(19) United States
(12) Patent Application Publication
(10) Pub. No.: US 2004/0220945 A1
(43) Pub. Date: Nov. 4, 2004

(54) Method, system and program product for selectively centralizing log entries in a computing environment

(75) Inventors: Anthony F. Pioli, Rhinebeck, NY (US); Bruce M. Potter, Saugerties, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY

(21) Appl. No.: 10/427,662

(22) Filed: May 1, 2003

(51) Int. Cl. G06F 7/00

(52) U.S. Cl. 707/100

(57) ABSTRACT

Method, system and program product are provided for selectively centralizing log entries in a computing environment. The selectively centralizing technique includes specifying at least one event subscription to at least one node of a plurality of nodes of the computing environment using an event infrastructure. The at least one event subscription results in the at least one node monitoring for at least one log entry in a log file of the node. Upon detection, the at least one log entry is automatically forwarded from the at least one node to a central management node. Using this technique, hierarchical log entry consolidation is also possible.

### TECHNICAL FIELD

This invention relates in general to a distributed computing environment, and more particularly, to a method, system and program product for selectively centralizing logging of events in a distributed computing environment employing specified event subscriptions.

### BACKGROUND OF THE INVENTION

Distributed systems are highly-available, scalable systems that are utilized in various situations, including those situations that require a high-throughput of work or continuous or nearly continuous availability of the system.

A distributed system that has the capability of sharing resources is referred to as a cluster. A cluster includes operating system instances, which share resources and collaborate with each other to perform system tasks. While various cluster systems exist today (such as the RS/6000 SP system offered by International Business Machines Corporation), further enhancement of these cluster systems is desired.

In a large cluster environment, it is often desirable for a system administrator to be able to view significant events throughout the cluster from a central location, referred to herein as the management server or central management node. This can be difficult to do, however. Normally, significant events are represented by a log entry in a particular log file on a node in the cluster where the event occurred. Should all log entries in all log files on all the nodes in a cluster be sent to the management server, this would result in too much network traffic and too much data on the management server. If all the log files are maintained only on the nodes, however, the administrator has to access many nodes to view the logs when trying to determine a problem. The log subsystem on UNIX and Linux, called syslog, has a forwarding mechanism that allows log entries of certain categories to be sent to a central location. This is an improvement, but these categories are not extensible and are not fine grained enough for many situations. Also, not all log entries go to the syslog, so some event entries of interest may be missed. Therefore, further enhancements are desired, for example, to facilitate central administration of a computing environment by facilitating defining of specific event log entries to be monitored for and automatically forwarded to a management server.

### SUMMARY OF THE INVENTION

The present invention provides, in one aspect, a method for selectively centralizing log entries in a computing environment. The method includes: specifying at least one event subscription to at least one node of a plurality of nodes of the computing environment to monitor for at least one log entry in a log file of the at least one node; and responsive to the at least one specified event subscription, automatically forwarding the at least one log entry from the at least one node to a central management node upon logging of the log entry to the log file of the at least one node.

In an enhanced aspect, the method can include specifying the at least one event subscription to multiple nodes of the plurality of nodes, with at least some nodes of the multiple nodes including multiple log files, wherein the at least one event subscription specified results in monitoring for the at least one log entry in any one of the multiple log files of the at least some nodes. Further, the method can include providing the at least one node with a log file watcher resource class facility to monitor for the at least one log entry in a log file of the node pursuant to receipt of the at least one specified event subscription. A method for hierarchical log entry consolidation is also described and claimed herein.

Systems and computer program products corresponding to the above-summarized methods are also described and claimed herein.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a computing environment incorporating and using aspects of the present invention;

FIG. 2 depicts an alternate example of a computing environment, having a plurality of clusters, incorporating and using aspects of the present invention;

FIG. 3 depicts one embodiment of a technique for selectively centralizing log entries in a computing environment having a node and a central management node, in accordance with aspects of the present invention;

FIG. 4 depicts one flowchart embodiment of processing for selectively centralizing log entries, in accordance with aspects of the present invention; and

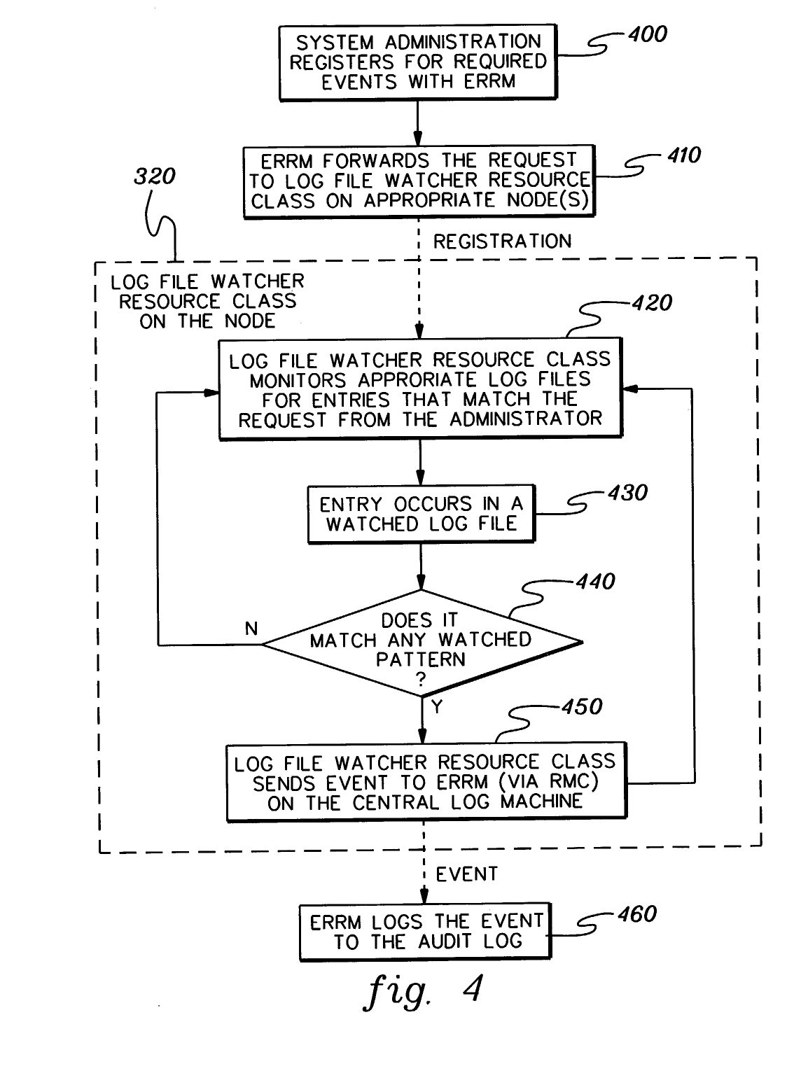

FIG. 5 depicts one example of a computing environment wherein hierarchical log entry consolidation can be accomplished, in accordance with aspects of the present invention.

### BEST MODE FOR CARRYING OUT THE INVENTION

In accordance with one or more aspects of the present invention, a method for selectively centralizing log entries in a computing environment is presented. Log entries are centralized using an event infrastructure of the computing environment. The event infrastructure is employed by a managing node to specify one or more event subscriptions to one or more nodes of the computing environment. An event subscription is used by a log file watch resource class facility or daemon resident on the node to monitor for a particular log entry in one or more log files of the node. Upon detection, the daemon automatically forwards the log entry from the at least one node to the central managing node.

Advantageously, in one aspect this invention allows an administrator to specify the log centralization criteria using the event infrastructure. Additionally, the consolidated log entries stored, for example, in an audit log, on the management server, can be further consolidated in an environment where there are multiple layers of management servers, thus achieving hierarchical log consolidation. For example, if a customer has several first level management servers that are consolidating log entries from respective nodes, then a top level management server can use the same event-based log consolidation approach to consolidate more significant entries from the first level management servers.

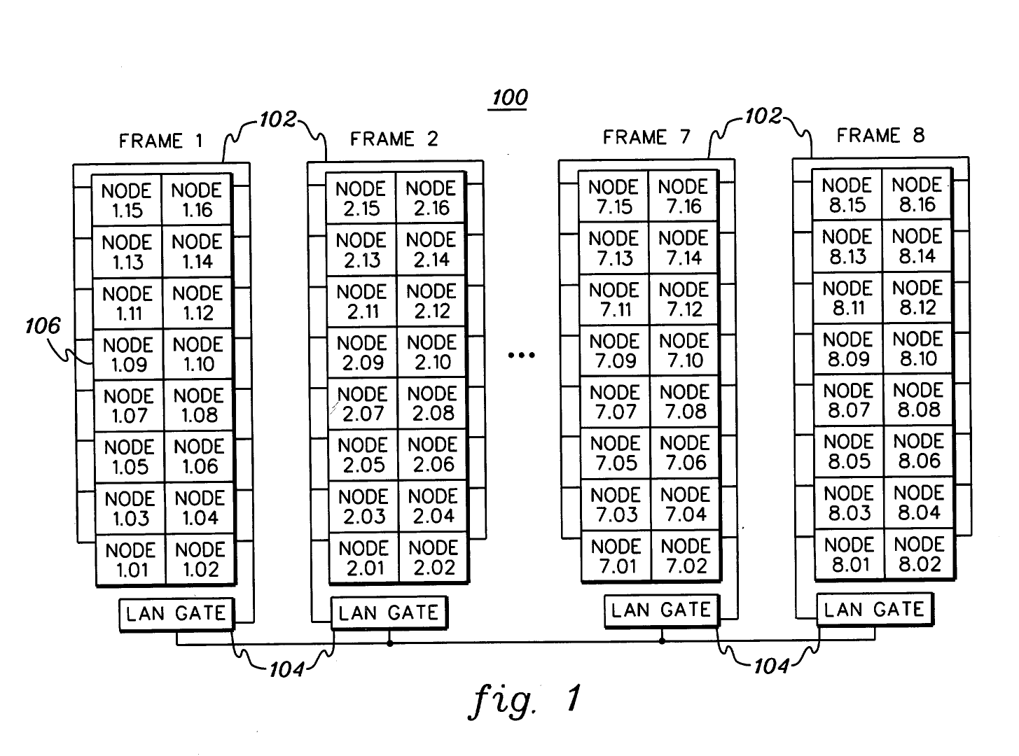

One example of a distributed computing environment incorporating and using aspects of the present invention is depicted in FIG. 1 and described herein. A distributed computing environment 100 includes, for instance, a plurality of frames 102 coupled to one another via a plurality of LAN gates 104. Frames 102 and LAN gates 104 are described in detail below.

In one example, distributed computing environment 100 includes eight (8) frames, each of which includes a plurality of processing nodes 106. In one instance, each frame includes sixteen (16) processing nodes (each having one or more processors). Each processing node is, for instance, a RISC/6000 computer running AIX, a UNIX based operating system offered by International Business Machines Corporation. Each processing node within a frame is coupled to the other processing nodes of the frame via, for example, an internal LAN connection. Additionally, each frame is coupled to the other frames via LAN gates 104.

As examples, each LAN gate 104 includes either a RISC/6000 computer, any computer network connection to the LAN, or a network router. However, these are only examples. It will be apparent to those skilled in the relevant art that there are other types of LAN gates, and that other mechanisms can also be used to couple the frames to one another.

The distributed computing environment of FIG. 1 is only one example. It is possible to have more or less than eight frames, or more or less than sixteen nodes per frame. Further, the processing nodes do not have to be RISC/6000 computers running AIX. Some or all of the processing nodes can include different types of computers and/or different operating systems. Further, a heterogeneous environment can include and utilize aspects of the invention, in which one or more of the nodes and/or operating systems of the environment are distinct from other nodes or operating systems of the environment. The nodes of such a heterogeneous environment interoperate, in that they collaborate and share resources with each other, as described herein. Further, aspects of the present invention can be used within a single computer system. All of these variations are considered a part of the claimed invention.

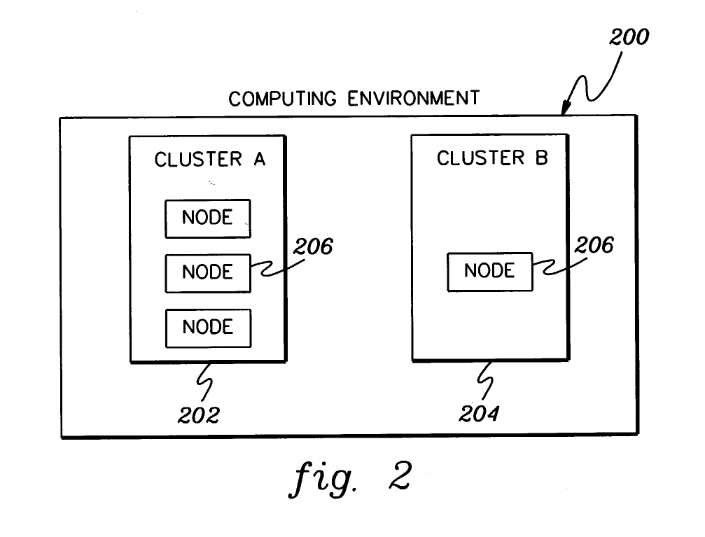

A distributed computing environment, which has the capability of sharing resources, is termed a cluster. In particular, a computing environment can include one or more clusters. For example, as shown in FIG. 2, a computing environment 200 includes two clusters: Cluster A 202 and Cluster B 204. Each cluster includes one or more nodes 206, which share resources and collaborate with each other in performing system tasks. Each node includes an individual copy of the operating system.

Clustering allows interconnecting two or more computers into a single, unified computing resource which offers a set of systemwide, shared resources that cooperate to provide flexibility, adaptability and increased availability to services essential to customers. Clusters have been devised, formally or informally, from many types of systems.

International Business Machines Corporation provides cluster systems management (CSM) software for Linux based systems which employs a sophisticated event infrastructure referred to as Resource, Monitor and Control (RMC). RMC is also provided by International Business Machines Corporation with AIX operating systems, General Parallel File Systems (GPFS) for Linux, and System Automation (SA) for Linux, and is described in various publications, including an IBM Redbooks publication entitled “A Practical Guide for Resource Monitoring and Control”, ISBN 0738426695, IBM Form Number SG24-6615-00 (August, 2002), the entirety of which is hereby incorporated herein by reference.

The resource monitoring control (RMC) software offered by International Business Machines Corporation can be extended to watch for additional events as described herein. RMC also provides a user interface in which an administrator can specify what events the administrator wishes to monitor for. In accordance with an aspect of the present invention, RMC is extended to watch for log entries in one or more specified log files on any node of a computing environment. This allows an administrator to make event subscriptions on a management server for log entries that match a particular pattern in a particular log file on any set of nodes. Because the default action when an event occurs is to log the event and associated information on the machine from which the subscription originated (i.e., the management server in this case), log entries of interest (and only those of interest) are automatically forwarded to the management server.

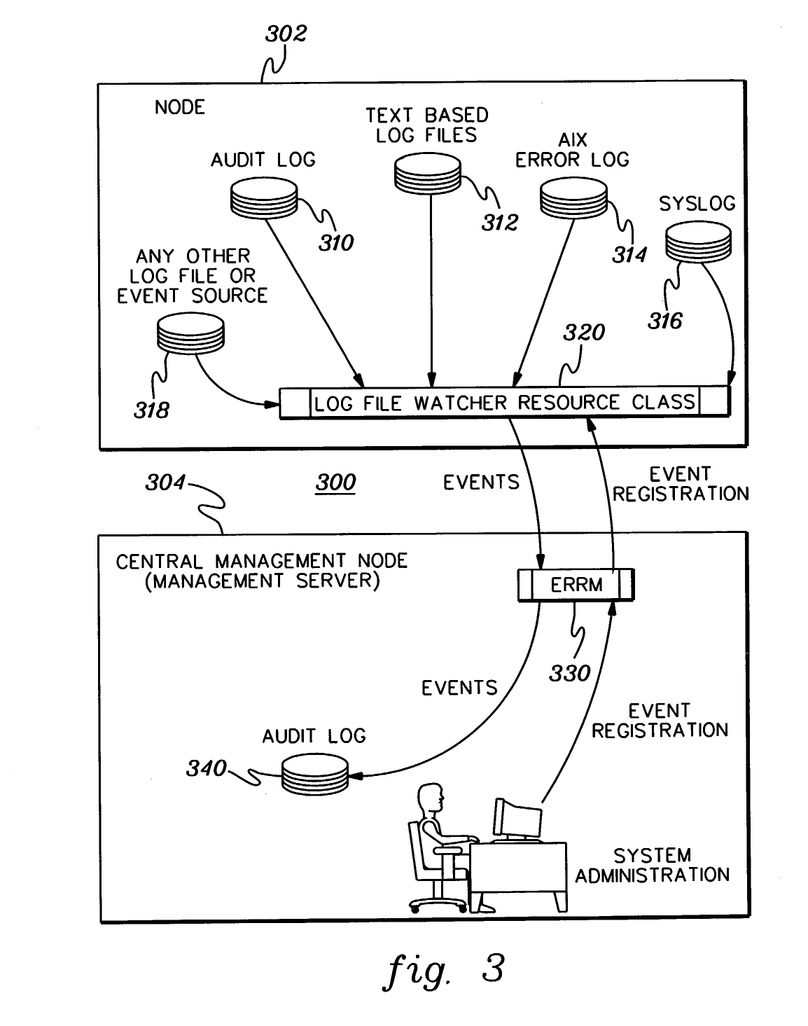

FIG. 3 depicts one embodiment of a computing environment, generally denoted 300, having one or more nodes 302 and a central management node 304. Node 302 has a plurality of logs, such as an audit log 310, a text based log file 312, an AIX error log 314, a syslog 316, and any other log file or event source 318. Syslog is a standard log file used on UNIX systems. AIX error log is an error log used on AIX operating systems. A text based log file is a log file that stores entries as text, while any other log file or event source comprises other log event sources that may not be text based. In accordance with an aspect of the present invention, the RMC infrastructure is extended by writing an additional resource class or code. This additional resource class, which can be readily programmed by one skilled in the art based on the teachings presented herein, watches the log files on a node for entries that match the specified event subscription (i.e., pattern). In the embodiment of FIG. 3, this resource class is labeled the log file watcher resource class 320, and in one embodiment is software that resides on each node being monitored, for example, each node in a cluster.

The resource monitor and control (RMC) software has another component called Event Response Resource Manager (ERRM) (see the above-incorporated publication entitled” “A Practical Guide for Resource Monitoring and Control”), which runs on the central management node 304. ERRM 330 is a system to persistently register conditions and responses to events. For example, in the present application, an event is a log entry of interest showing up through the log file watcher resource class of a node being monitored. ERRM 330 allows administrators to persistently specify conditions that should be monitored for and responses that should be run when the condition (i.e., event) occurs. One predefined response that is provided to the user is to simply log the event to a local audit log 340. The audit log is another component of the resource monitor and control (RMC) system, which is an efficient log mechanism that allows for wrapping of the log, searching of the log, and National Language Support (NLS) of the entries.

One example of a process for selectively centralizing log entries in accordance with an aspect of the present invention is described below with reference to FIGS. 3 & 4. Initially, system administration provides event registration of desired or required events using ERRM at the central management node 400. In each event subscription, the administrator specifies the log file to be watched, the pattern of log entries to be matched, and which nodes event subscriptions should be sent to. Normally, the administrator associates with this event subscription a response that simply logs the event to the audit log. Although other responses could also be associated with this event subscription. When a condition is defined, ERRM makes an event subscription with the log file watcher resource class on each node specified in the condition. The log file name and the pattern are passed to the RMC daemon on each node as normal event subscription parameters 410. The log file watcher resource class facility 320 on the appropriate node(s) receives the event registration information and monitors the appropriate log file(s) for an entry that matches a request from the system administrator 420. When an entry occurs in a watched log file 430, the log file watcher resource class facility inquires whether the entry matches any pattern that is currently being watched responsive to the event registration 440. This process continues until a matching pattern is detected. When a log entry to this file on any node occurs that matches the pattern, the resource class and RMC daemon on the node recognize this and create an event that is sent to ERRM on the management server 450. The event data contains the log entry message. When ERRM receives it, it runs the associated response, which puts the log entry in the audit log 460. The audit log on the management server, therefore, contains all the log entries of interest from all the nodes. The audit log can be searched and filtered as the administrator wants. If the administrator needs the full contents of a particular log file to further diagnose a problem, the administrator can go to that node and view it.

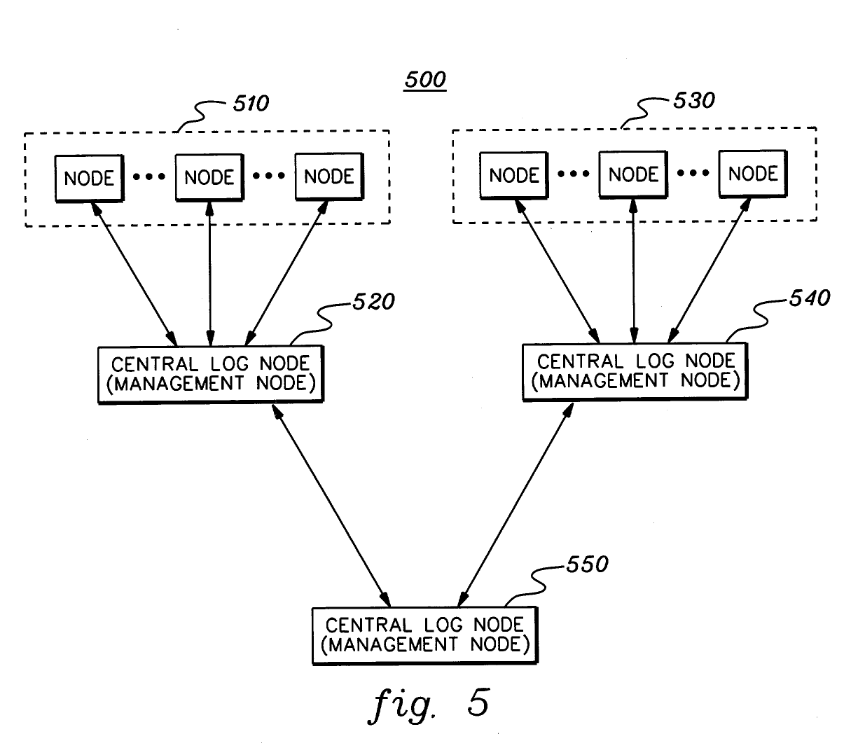

FIG. 5 depicts an enhanced aspect of the present invention wherein a first layer of central logging nodes 520 & 540 accumulate selected log entries from multiple nodes in different groups 510, 530 of a computing environment 500 as explained above. These log entries are further consolidated by a higher level central logging node 550. For example, using the log file watcher resource class facility and ERRM system described hereinabove, the top level management server creates an event condition that instructs the event subsystem to watch for specific entries in the audit logs of the first level management servers.

Advantageously, presented hereinabove is a technique for selectively centralizing log entries in a computing environment which reduces network bandwidth used in a cluster environment to manage the environment, and reduces the amount of disk space used on the management server. The technique reuses existing event infrastructure, and allows an administrator to specify the log centralization criteria using a familiar event monitoring interface. Further, the technique presented herein for selectively centralizing log entries is able to watch multiple log files on multiple nodes in a computing environment, not just syslog files, and ensures timely delivery of log entries (as opposed to once a day copying of an entire log file). Still further, the concepts disclosed herein could readily be made secure by using existing security features of IBM's Reliable Scalable Cluster Technology (RSCT) to authenticate, authorize, and encrypt events as they arrive at the central log machine.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method for selectively centralizing log entries in a computing environment, said method comprising:
specifying at least one event subscription to at least one node of a plurality of nodes of the computing environment to monitor for at least one log entry in a log file of the at least one node; and
responsive to the at least one specified event subscription, automatically forwarding the at least one log entry from the at least one node to a central management node upon logging of the log entry to the log file of the at least one node.

2. The method of claim 1, further comprising specifying the at least one event subscription to multiple nodes of the plurality of nodes in the computing environment, wherein at least some nodes of the multiple nodes include multiple log files, and wherein the at least one event subscription specified results in monitoring for the at least one log entry in the multiple log files of the at least some nodes.

3. The method of claim 2, wherein the multiple log files comprise at least some of a syslog file, an error log file, a text based log file, and an audit log file.

4. The method of claim 2, further comprising specifying the at least one event subscription to each node of the plurality of nodes in the computing environment, wherein at least some nodes of the plurality of nodes include multiple log files, and wherein the at least one event subscription specified results in monitoring for the at least one log entry in the multiple log files of the plurality of nodes.

5. The method of claim 1, further comprising providing the at least one node of the plurality of nodes with a log file watcher resource class facility to monitor for the at least one log entry in a log file of the at least one node responsive to receipt of the at least one specified event subscription.

6. The method of claim 1, wherein the at least one node comprises at least one management node of the computing environment, and wherein the automatically forwarding comprises automatically forwarding the at least one log entry from the at least one management node to the central management node, wherein the log entry of interest is automatically forwarded from the at least one management node to the central management node responsive to the at least one specified event subscription, thereby providing hierarchical log entry consolidation.

7. The method of claim 1, wherein the at least one central management node comprises one central management node of a plurality of central management nodes in the computing environment, and wherein the method further comprises specifying at least one additional event subscription to at least one central management node of the plurality of central management nodes in the computing environment to monitor for at least one log entry in a log file at the at least one central management node, and automatically forwarding the at least one log entry from the at least one central management node to a higher level central management node, wherein only the log entry specified by the at least one additional event subscription is automatically forwarded from the at least one central management node to the high level central management node, thereby providing hierarchical log entry consolidation.

8. A system for selectively centralizing log entries in a computing environment, said system comprising:
means for specifying at least one event subscription to at least one node of a plurality of nodes of the computing environment to monitor for at least one log entry in a log file of the at least one node; and
means for automatically forwarding the at least one log entry from the at least one node to a central management node upon logging of the log entry to the log file of the at least one node, wherein said means for automatically forwarding is responsive to the at least one specified event subscription.

9. The system of claim 8, further comprising means for specifying the at least one event subscription to multiple nodes of the plurality of nodes in the computing environment, wherein at least some nodes of the multiple nodes include multiple log files, and wherein the at least one event subscription specified results in monitoring for the at least one log entry in the multiple log files of the at least some nodes.

10. The system of claim 9, wherein the multiple log files comprise at least some of a syslog file, an error log file, a text based log file, and an audit log file.

11. The system of claim 9, further comprising means for specifying the at least one event subscription to each node of the plurality of nodes in the computing environment, wherein at least some nodes of the plurality of nodes include multiple log files, and wherein the at least one event subscription specified results in monitoring for the at least one log entry in the multiple log files of the plurality of nodes.

12. The system of claim 8, further comprising means for providing the at least one node of the plurality of nodes with a log file watcher resource class facility to monitor for the at least one log entry in a log file of the at least one node responsive to receipt of the at least one specified event subscription.

13. The system of claim 8, wherein the at least one node comprises at least one management node of the computing environment, and wherein the means for automatically forwarding comprises means for automatically forwarding the at least one log entry from the at least one management node to the central management node, wherein the log entry of interest is automatically forwarded from the at least one management node to the central management node responsive to the at least one specified event subscription, thereby providing hierarchical log entry consolidation.

14. The system of claim 8, wherein the at least one central management node comprises one central management node of a plurality of central management nodes in the computing environment, and wherein the system further comprises means for specifying at least one additional event subscription to at least one central management node of the plurality of central management nodes in the computing environment to monitor for at least one log entry in a log file at the at least one central management node, and means for automatically forwarding the at least one log entry from the at least one central management node to a higher level central management node, wherein only the log entry specified by the at least one additional event subscription is automatically forwarded from the at least one central management node to the high level central management node, thereby providing hierarchical log entry consolidation.

15. At least one program storage device readable by a machine, tangibly embodying at least one program of instructions executable by the machine to perform a method for selectively centralizing log entries in a computing environment, said method comprising:
specifying at least one event subscription to at least one node of a plurality of nodes of the computing environment to monitor for at least one log entry in a log file of the at least one node; and
responsive to the at least one specified event subscription, automatically forwarding the at least one log entry from the at least one node to a central management node upon logging of the log entry to the log file of the at least one node.

16. The at least one program storage device of claim 15, further comprising specifying the at least one event subscription to multiple nodes of the plurality of nodes in the computing environment, wherein at least some nodes of the multiple nodes include multiple log files, and wherein the at least one event subscription specified results in monitoring for the at least one log entry in the multiple log files of the at least some nodes.

17. The at least one program storage device of claim 16, wherein the multiple log files comprise at least some of a syslog file, an error log file, a text based log file, and an audit log file.

18. The at least one program storage device of claim 16, further comprising specifying the at least one event subscription to each node of the plurality of nodes in the computing environment, wherein at least some nodes of the plurality of nodes include multiple log files, and wherein the at least one event subscription specified results in monitoring for the at least one log entry in the multiple log files of the plurality of nodes.

19. The at least one program storage device of claim 15, further comprising providing the at least one node of the plurality of nodes with a log file watcher resource class facility to monitor for the at least one log entry in a log file of the at least one node responsive to receipt of the at least one specified event subscription.

20. The at least one program storage device of claim 15, wherein the at least one central management node comprises one central management node of a plurality of central management nodes in the computing environment, and wherein the method further comprises specifying at least one additional event subscription to at least one central management node of the plurality of central management nodes in the computing environment to monitor for at least one log entry in a log file at the at least one central management node, and automatically forwarding the at least one log entry from the at least one central management node to a higher level central management node, wherein only the log entry specified by the at least one additional event subscription is automatically forwarded from the at least one central management node to the high level central management node, thereby providing hierarchical log entry consolidation.
